(19) United States
(12) Patent Application Publication
(10) Pub. No.: US 2013/0162844 A1
(43) Pub. Date: Jun. 27, 2013

(54) REMOTE TARGET VIEWING AND CONTROL FOR IMAGE-CAPTURE DEVICE

(71) Applicant: Joseph I. Douek, New York, NY (US)

(72) Inventor: Joseph I. Douek, New York, NY (US)

(21) Appl. No.: 13/724,592

(22) Filed: Dec. 21, 2012

Related U.S. Application Data
(60) Provisional application No. 61/579,614, filed on Dec. 22, 2011.

(51) Int. Cl. G06F 3/00

(52) U.S. Cl. CPC G06F 3/005
USPC 348/207.1

(57) ABSTRACT

A system is made up of a remote access device with mechanisms to visualize images and configured to send and receive wireless signals from and to the remote access device. The system also includes an image capture device which has mechanisms to view an image of a target and is configured to send and receive signals from and to the image capture device. The system also includes a terminal coupling the remote access device and the image capture device to allow the image of the target as viewed by the image capture device to appear on the remote access device.

This application claims priority to U.S. Provisional Patent Application Ser. No. 61/579,614, filed on Dec. 22, 2012, the disclosures of which are hereby incorporated herein by reference in their entirety.

### FIELD OF THE INVENTION

Disclosed are embodiments of the invention which relate to, among other things, remote access to image viewing and image capture control of image capture devices.

### BACKGROUND

Remote control of image capture devices exists in the art allowing users to remotely command the image capturing process of their particular device. Such technologies have been exploited by Canon Rebel XSi and Canon EOS software.

Devices and device mounts used in the image capture process have been made to receive input from users at remote locations to control timing, quality and type of images captured.

### SUMMARY OF THE INVENTION

A remote access device communicates via one or more wireless and wired connections with an image capture device to review in real-time the image capture process of the image capture device facing a target.

A remote access device communicates via one or more wireless connections with an image capture device to review in real-time the image capture process of the image capture device facing the location of the user of the remote access device.

A remote access device with visual display means for previewing the image capture process of an image capture device can control the capture of the images from a remote location.

### BRIEF DESCRIPTION OF THE DRAWINGS

FIG. 1 illustrates an exemplary overview of the device interactions of the present invention.

FIG. 2 illustrates remote access of an image capture device via a wireless terminal according to an exemplary embodiment of the present invention.

FIG. 3 illustrates remote access of an image capture device via satellite according to an exemplary embodiment of the present invention.

FIG. 4 illustrates remote access of an image capture device by multiple users in a network according to an exemplary embodiment of the present invention.

FIG. 5 illustrates an image capture device for remote transmission of images captured according to exemplary embodiments of the present invention.

In the drawings like characters of reference indicate corresponding parts in the different figures.

### DETAILED DESCRIPTION

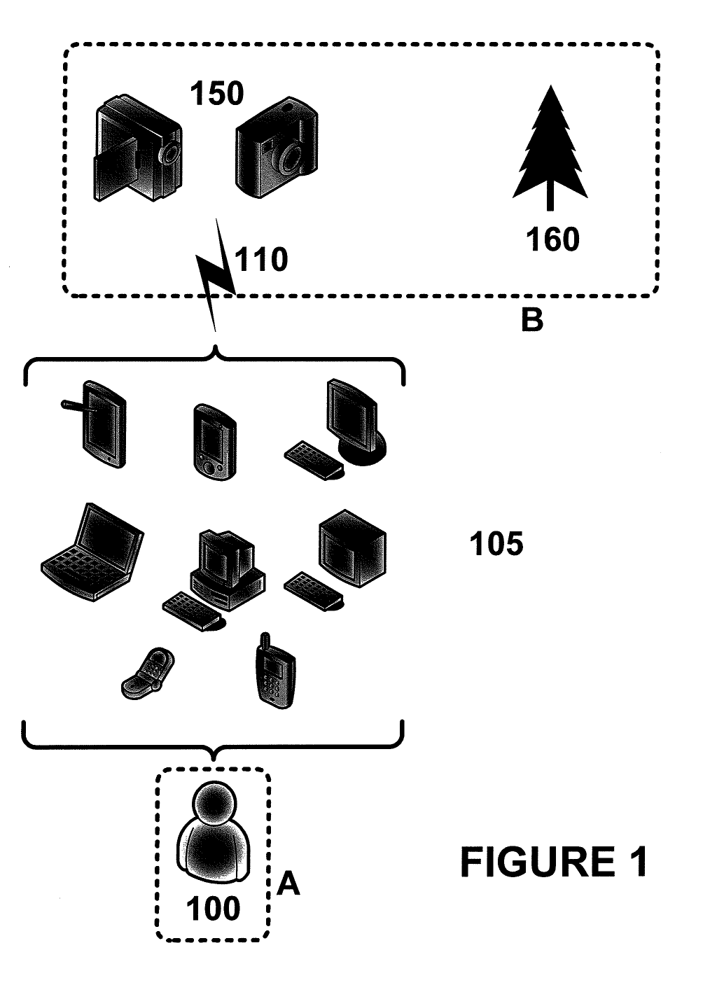

FIG. 1 illustrates a user 100, a remote access device (RAD) 105, an image capture device (ICD) 150 and a target for image capture 160. User 100 may be located in a location “A” and target 160 in a location “B”. According to one embodiment of the present invention, locations A and B are separated by a distance which prevents user 100 from being physically able to capture the image of target 160. According to another embodiment of the present invention, locations A and B may contain different environmental conditions preventing user 100 from being physically able to capture the image of target 160. According to yet another embodiment of the present invention, where ICD 150 is in location B, user 100 may be located at location B but in a position distant from ICD 150 (location A) such that user 100 cannot physically control ICD 150. For example, user 100 may not be able to see the image of user 100 in ICD 150 from his or her position at location A/B. In this example, user 100 would be able to view the image as it is seen by ICD 150 through a view screen on RAD 105. User 100 may further control ICD 150's image capture of the user 100 via RAD 105.

RAD 105 may be any form of personal computing device, including, but not limited to, laptops, desktop computers, personal digital assistants (PDA's), tablet personal computers, iPhones or other “smart phone” devices, iPads, Blackberry devices, cell phones, and hybridized and/or accessorized versions of the same. Those skilled in the art may appreciate that RAD 105 may be any type of electronic device suitable for connecting wirelessly to a remote data point (e.g., a server or personal computer). In a preferred embodiment, RAD 105 comprises an iPhone with wireless capabilities.

RAD 105 may also possess one or more viewing screens capable of rendering images from internal or external sources. RAD 105 may provide for a range of screen resolutions and image viewing capabilities (e.g., viewing of single image of a digital single lens reflex (DSLR) camera or mpeg media recorded by camcorder). Those skilled in the art would appreciate the technologies that may be used to configure RAD 105 view screens to sufficiently render an image from any one of many ICD 150 known to those skilled in the art. By way of example, a laptop may contain a USB television tuner, such as the Elgato EyeTV Hybrid—ATSC HDTV/QAM receiver/analog TV/radio tuner/video input adapter or other such tuners with composite video-in capabilities, to allow reception of a DSLR image on the laptop for direct viewing on a television of adequate resolution. Similar laptop viewing of digital cameras located in the same locations as its users and targets may likewise be viewable as per Canon Rebel XSi and accompanying Canon EOS software.

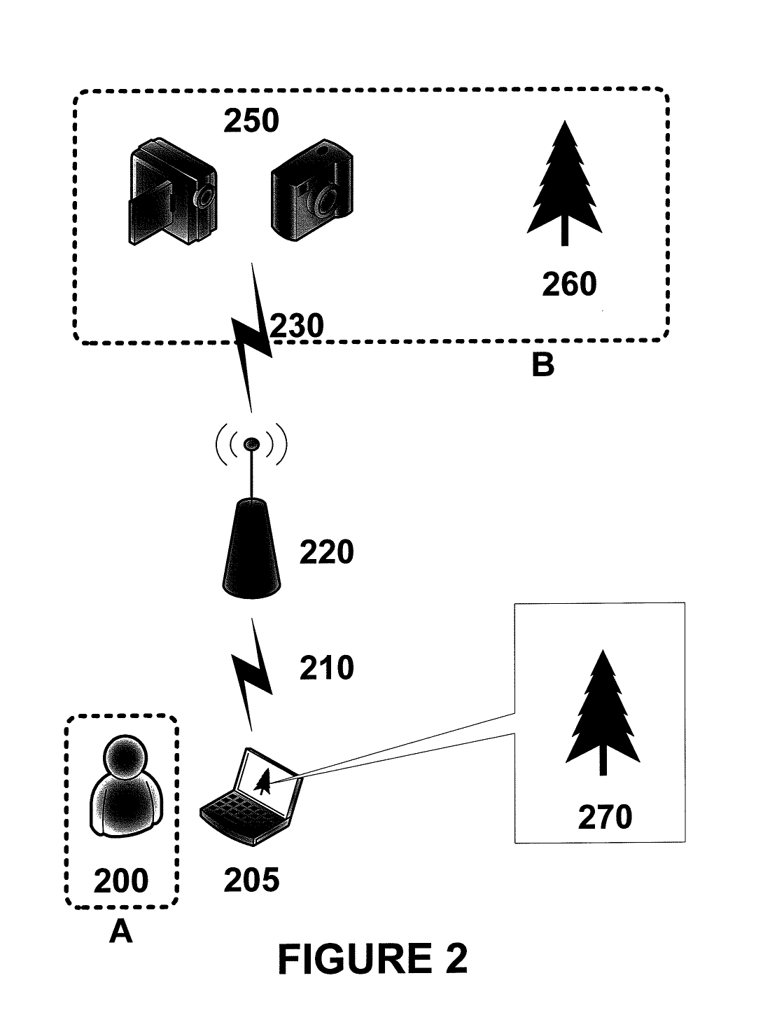

RAD 105 may access the image captured on ICD 150 through a connection 110 that may comprise any electronic coupling between one or more electronic devices, including, but not limited to, local area networks, wireless access networks, Bluetooth, and 802.11a/b/g/n wireless (WiFi) technologies. Alternatively, connection 110 may be a satellite connection such as the type utilized in Global Positioning System (GPS) technologies and direct broadcast satellites (DBS) technologies. Those skilled in the art may understand other electronic couplings that can achieve the result of establishing connection 110 between a user's RAD 105 and ICD 150 in accordance with the disclosed embodiments of the present invention, for example, those connections illustrated in FIGS. 2 through 5.

As illustrated in FIG. 1, through RAD 105, user 100 in location A may view the image of target 160 at location B as that image appears in ICD 150. A suitable RAD 105 according to the embodiments of the present invention would have the capabilities to present the captured image of target 160 on its user interface. The captured image of target 160 may be compressed, modified or otherwise digitally prepared by ICD 150, RAD 105 or intervening devices along connection 110 to be viewed by user 100 at location A.

In a preferred embodiment, user 100 may be the target for image capture. Thus, a user 100 may wirelessly control ICD 150 to capture an image of user 100 using RAD 105 to capture the image. In this way, a user 100 may be able to take his or her own picture from a location which precludes user 100 from physically viewing the ICD, yet being able to view the ICD image capture screen on the user's compatible RAD 105. Those skilled in the art may be able to implement this preferred embodiment using one or more of the devices, systems and functionalities according to the embodiments disclosed herein.

With reference to FIG. 2, a user 200 at location A may remotely access and view the image 270 of target 260 while target 260 is located at location B. User 200 views image 270 on the user's RAD 205. An exemplary RAD 205 may be a laptop computer. In another exemplary embodiment, RAD 205 may be an iPhone or other type of smart phone device. User 200 may view target 260 as it appears at location B (e.g., in the viewing mechanisms in ICD 250) via the user's RAD 205. In the exemplary embodiment of the present invention according to FIG. 2, RAD 205 accesses image 270 of target 260 on ICD 250 via a wireless or wired connection 210 to wireless terminal 220. Those skilled in the art would appreciate many devices may be suitable for use as a wireless terminal according to FIG. 2, e.g., a wireless modem or wireless/wired connections to a WiFi receiver.

It may also be appreciated that one or more RADs may be suitable as connection 210 to wireless terminal 220 from RAD 205. In the case of a wired connection, RAD 205 may achieve its connection to wireless terminal 220 via a user-to-user network, peer-to-peer network or a series of networks (e.g., the internet). Alternatively, user 200 may connect to wireless terminal 220 via a virtual private network (VPN), another type of remote access platform (e.g., Citrix) or a storage area network (SAN). In the case of a wireless connection, one or more RADs suitable to act as a wireless connection 210 between RAD 205 and wireless terminal 220, may include wireless area networks (WAN), remote access platforms (e.g., Citrix) or a storage area network (SAN).

According to the exemplary embodiment of the present invention illustrated in FIG. 2, wireless terminal 220 may also be connected wirelessly or by wired connection 230 to ICD 250. An exemplary connection 230 may comprise other wireless terminals, other RAD's or a combination of the two. Wireless terminal 220 may not be solely dedicated to packet transference between ICD 250 and RAD 205, but may accommodate other communications either within connection 230 or from other external locations not depicted in FIG. 2.

An exemplary wireless terminal 220 may be equipped so that its connections 230 and 210 with ICD 250 and RAD 205, respectively, are sufficiently robust to establish communications between the devices over a distance between locations A and B. For example, the wireless terminal 220 in a wireless network 210, 230 would need sufficient bandwidth and/or wireless terminal queuing capabilities to permit real-time viewing by a user 200 in remote locations, e.g., a user in New York trying to take a digital camera picture of a sunset in California. Those skilled in the art would appreciate the balance between geographical and technical requirements necessary to allow wireless terminal 220 to function in accordance with the present invention to permit viewing of remote targets 260 at user 200's RAD 205.

User 200 may view an image 270 of the target 260 on a view screen of RAD 205 as that target 260 is perceived by ICD 250. However, the view screen portion of RAD 205 may not necessarily possess the same level of detail and number of pixels as its corresponding ICD 250. In one embodiment, the resolution of ICD 250 is identical to the resolution of the viewing screen of RAD 205. In an alternative embodiment, the resolution of the image captured by ICD 250 is greater than that of RAD 205. According to this embodiment, either ICD 250 or RAD 205 may contain software or related image control technologies known to those skilled in the art to render the image to be capable for viewing on the viewing screen of RAD 205. Alternatively, wireless terminal 220 may be configured to adjust images captured by ICD 250 so that they are configured to appear on a viewing screen of RAD 205. As discussed above, RAD 205 may possess accessories to display target 260 as an image 270 with a resolution equal to or possibly greater than that of ICD 250.

It is a further embodiment of the present invention according to FIG. 2, that user 200 can manipulate, change or otherwise impact the image 270 on RAD 205 and have that manipulation or change reflected at ICD 250. For example, when user 200 zooms in on a portion of image 270 on RAD 205 the same zooming command is communicated via connections 210 and 230 via wireless terminal 220 to ICD 250. According to the aforementioned example, ICD 250 would take necessary steps to zoom in on target 260. The command from user 200 from RAD 205 may not be exactly replicated by ICD 250, but may be reflected to the best technological extent available to ICD 250. In this way, a user 200 can remotely control the image capturing experience of target 260 by selectively handling a previously generated image 270 of target 260 on RAD 205.

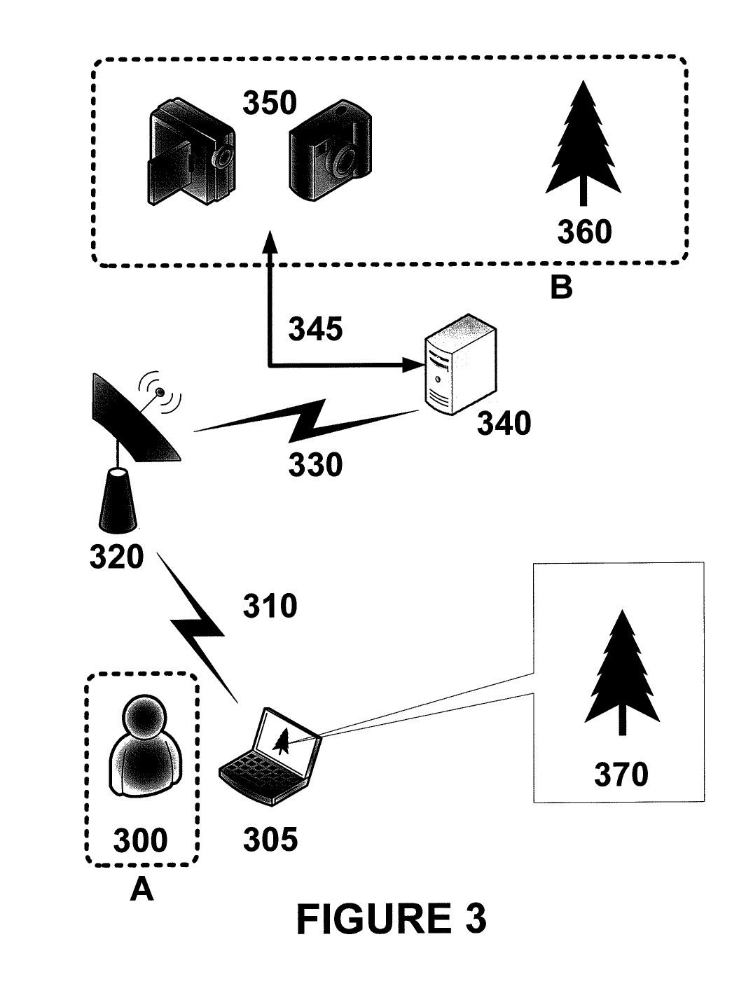

With reference to the exemplary embodiment of the present invention according to FIG. 3, user 300, in location A, remotely controls ICD 350 to capture an image 370 of target 360 at a remote location B on the user's RAD 305. RAD 305 may connect to ICD 350 via wired or wireless connections 310 and 345 as previously discussed above with reference to FIGS. 1 and 2. However, connection 330 illustrated in FIG. 3 is wireless only and involves use of satellite 320 for receiving and transmitting commands and images related to the image capturing experience of remote target 360.

In addition to that previously described, satellite 320 may include, geostationary satellites, medium Earth orbit (MEO) and low Earth orbit (LEO) satellites, portable satellite modems (e.g., Inmarsat's broadband global area network (BGAN)) or general packet radio service (GPRS)/enhanced data rates for GSM evolution (EDGE). An exemplary satellite 320 according to one embodiment of the present invention may be a dedicated satellite 320 to the system described with respect to FIG. 3. Those skilled in the art would recognize a dedicated satellite 320 operating for the purposes of uploading images from an ICD 350, may have minimal upload volume so as to reduce satellite 320's dish size and/or reduce cost of satellite communication operation. Alternatively, data packet transference via a shared satellite 320 may involve preparing delivery and receipt of controls and captured images from and between RAD 305/ICD 350.

Those skilled in the art may appreciate that ICD 350 may receive inputs and deliver outputs through satellite 320. However, in another aspect of the exemplary embodiment of the present invention according to FIG. 3, satellite 320 may wirelessly communicate via wireless connection 330 with hub device 340. Hub device 340 may be any suitable receiver unit known to those skilled in the art to process satellite communications and translate the same into usable data by peripheral devices (e.g., peripheral devices such as ICD 350). Hub device 340 may be similar in form and configuration to a RAD device as described in the embodiments of the present invention (e.g., a workstation computer) or other non-RAD devices (e.g., server, modem).

Similar to connections from wireless terminal 220 to ICD 250 in FIG. 2, connection 345 would similarly allow Hub device 340 to connect with ICD 350. It may also be appreciated that Hub device 340 may comprise one or more similar hub devices to provide for a network of computers (e.g., internet), to communicate user 300 commands through satellite 320 to ICD 350.

The functionalities and controls of user 300 at RAD 305 may be similar to those described with respect to user 200 at RAD 205 in relation to the exemplary embodiment of the present invention according to FIG. 2. Alternatively, user 300 may control satellite 320 to account for the image or media sought to be captured by ICD 350, e.g., adjusting for greater bandwidth usage, selecting different satellite channel. Further, user 300 may control hub 340 to account for the image or media sought to be captured by ICD 350, e.g., prioritizing images to be captured, constraining ICD 350 mechanical configurations.

According to the exemplary embodiment illustrated in FIG. 3, user 300 may view image 370 while in motion due to the expansive reach of satellite 320. Thus, user 300 may not need to be stationary to control the image capture experience at ICD 350. Alternatively, user 300 may be able to control ICD 350 via satellite television services using a remote and television together as RAD 305. Those skilled in the art may appreciate the technological capabilities already developed to implement such a network and that the same can be put to ready use in accordance with the various embodiments of the present invention.

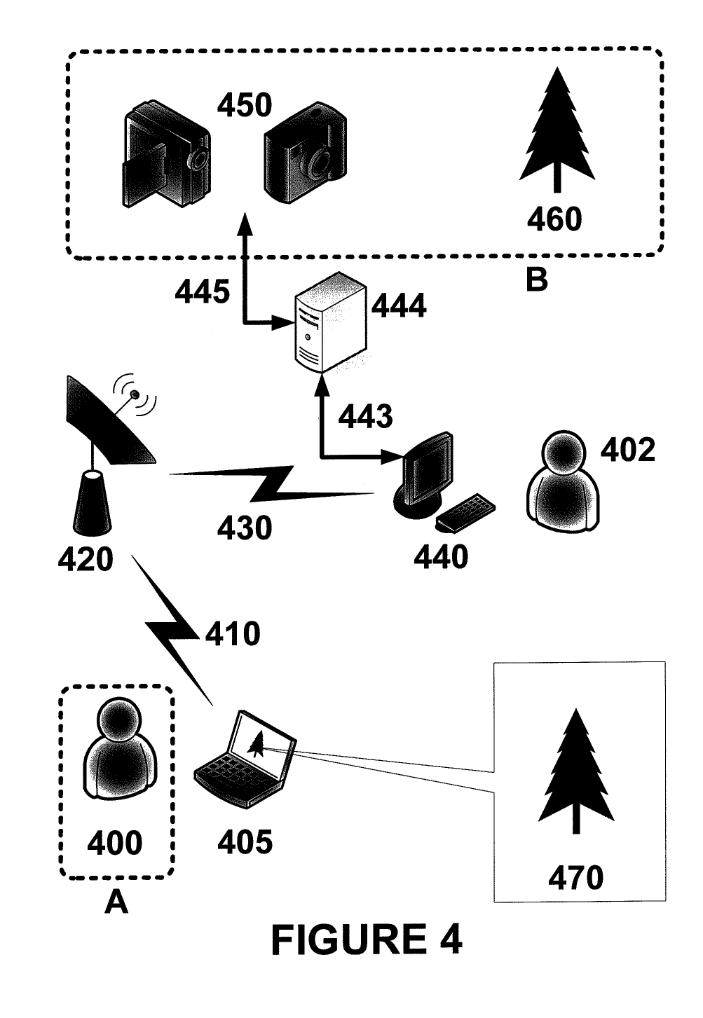

With reference to the exemplary embodiment of the present invention as illustrated in FIG. 4, user 400 utilizes RAD 405 to connect to satellite 420 and thereby control ICD 450 to capture image 480 of remote target 460. The illustrated embodiment of the present invention according to FIG. 4 contains a wireless or wired connection 410 to satellite 420, a wireless connection 430 to RAD 440 operated by user 402, a wireless or wired connection 443 to hub device 444 from RAD 440 and a wireless or wired connection 445 form hub device 444 to ICD 450. A user 400 (in location A) may control the image capturing experience at ICD 450 of target 460 (located in location B) via the aforementioned connections 410, 430, 443 and 445 and devices 420, 440 and 444 so as to view an image 470 of target 460 on the user's RAD 405.

According to the exemplary embodiment illustrated in FIG. 4, a user 400 may coordinate with user 402 to capture image 470 of target 460. User 402 may be located anywhere along the connection path from RAD 405 to ICD 450. A RAD 440 of user 402 may have similar capabilities and functionalities as RAD 405. Those skilled in the art may recognize additional functionalities required of RAD 440 to receive satellite signals via connection 430 from a satellite 420. An alternate wireless terminal 220 or hub 444 may be substituted for satellite 420 for technological convenience or cost savings in connection to RAD 440. As illustrated in FIG. 4, user 402 may post-process image 470 on RAD 440 before sending the same to user 400 at RAD 405. Alternatively, a user 400 whose RAD 405 may lack technological capabilities to view image 480 may receive images that have been rendered into a compatible format at RAD 440 by user 402. As illustrated, a peer-to-peer image capturing experience network may be implemented to allow multiple users to participate in the operation and function of ICD 450 on target 460 for the remote image capturing experience.

In an exemplary embodiment of the present invention according to FIG. 4, users may jointly control certain aspects of ICD 450 by their individual RADs 405, 440 to captures an image 470 of target 460 at location B. Alternatively, user 402 may operate hub 444, connections 443, 445 or satellite 420 to assist in the image capture experience of ICD 450 controlled by user 400 through RAD 405. According to this alternative embodiment, a user 402 may be a human or algorithm programmable into a computer readable medium. As an algorithm, user 402 may contain a storage of characteristics and patterns of user 400's previous image capturing experiences. When receiving commands from user 400's RAD 405, user 402 may augment the system of connections 443, 445, hub 444, ICD 450 and satellite 420 to reproduce similar image capturing experiences (e.g., replicating certain previous lens exposures desired by user 400 or replicating previously-used image capturing angles).

Where user 402 may be a human, user 402 may assist in training photography of user 400 from a remote location to remotely control user 400's image capturing experience at ICD 450. Alternatively, user 400 and user 402 as well as any number of additional users may participate in the image capturing experience at ICD 450.

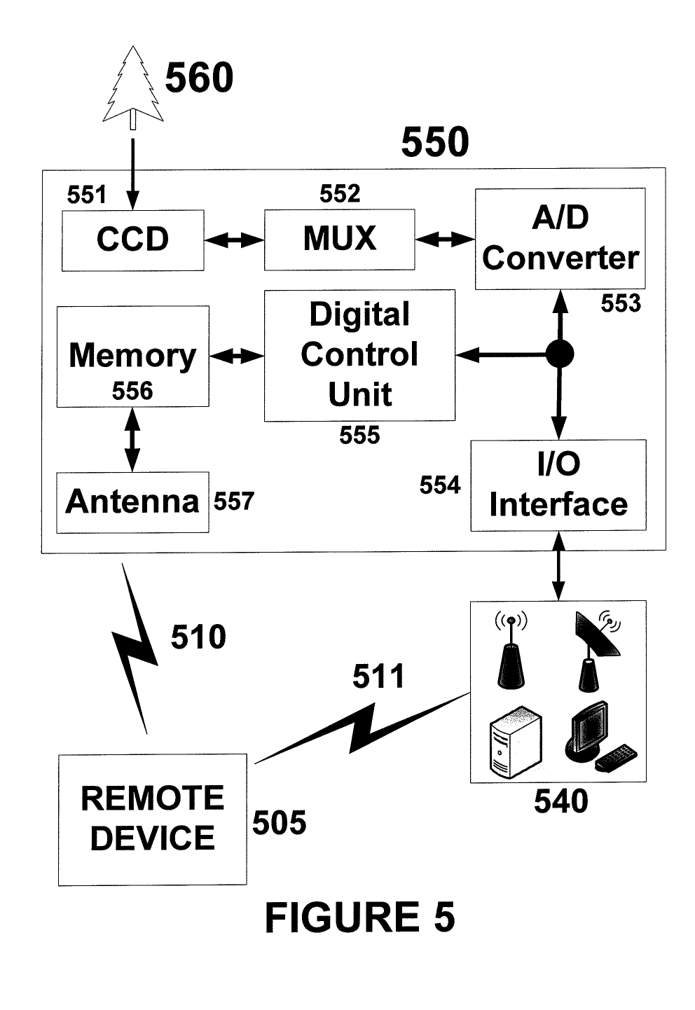

Referring now to the exemplary embodiment of the present invention according to FIG. 5, an exemplary ICD 550 according to the various embodiments of the present invention may be shown in block diagram view. An exemplary ICD 550 may contain a charge coupling device (CCD) 551 to receive the captured image of target 560. The signals from CCD 551 may be electronically transmitted through multiplexer (MUX) 552 and may be processed in an analog/digital converter (A/D converter) 553. Those skilled in the art may recognize numerous variants of image capture and image signal processing that would function in accordance with the disclosed embodiments of the present invention. A converted signal of captured image of target 560 may be sent out of ICD 550 via Input/output interface 554 to connection to one or more devices 540 (e.g., wireless terminals, hubs, RADs, satellites), which in turn communicate via connection 511 to a remote device (e.g., RAD) 505.

In an alternative arrangement to what has been previously described, a converted signal of captured image of target 560 may enter a digital control unit 555 for post-capture processing. Those skilled in the art may also recognize numerous types of digital control units that may function to achieve the desired results of the disclosed embodiments of the present invention. In one embodiment, digital control unit may compress the size of the image captured at CCD 551 so that it more easily can be communicated from ICD 550 to a remote device 505. In another embodiment, digital control unit may reform the file containing the captured image so it can be received by the designated remote device 505. In a further embodiment, digital control unit may format a captured image in accordance with pre-existing commands from a remote device 505 or similar devices 540 in the system architecture such as those previously described in conjunction with the exemplary embodiments of the present invention in FIGS. 1-4.

Following captured image processing from ICD 550 mechanisms MUX 552, A/D converter 553 and digital control unit 555, the data reflecting target 560 within ICD 550 may be stored in one or more suitable memory devices 556 of the type known to those skilled in the art. Upon appropriate command, ICD 550 may provide access to images stored in memory 556 via antenna 557. Those skilled in the art may appreciate antenna 557 may be internal or external of ICD 550 and may comprise any number of appropriate wireless transmission functionalities. In one example, ICD 550 may contain an antenna 557 capable of satellite (e.g., as in a GPS data communications) or WiFi or Bluetooth connections 510. Alternatively, antenna 557 may be built into ICD 550, such as in, for example, digital wireless security cameras or digital cameras employing Eye-Fi wireless SD cards.

In one preferred embodiment, a user may use his or her iPhone to access a digital camera located in a distant location. By paying a fee or inputting a user name/password, the user can control the digital camera with his or her iPhone and take a picture to save on the iPhone memory. In another preferred embodiment, a user may use his or her laptop to access a digital camera located underwater or in the air to capture an image or video at the digital camera's location.

In another preferred embodiment, a user may use his or her iPhone, or other type of smartphone technology, to view the contents of the visual screen of a digital camera located distally from the user's location so that before using the digital camera to take a picture of the user and surrounding objects, the user can view, change or otherwise manipulate the digital camera with his or her iPhone.

The above examples should be considered to be exemplary embodiments, and are in no way limiting of the present invention. Thus, while the description above refers to particular embodiments, it will be understood that many modifications may be made without departing from the spirit thereof.

I claim:

1. A system, comprising:
a remote access device having visualization means and means for sending and receiving wireless signals from and to the remote access device;
an image capture device having means for viewing an image of a target and means for sending and receiving signals from and to the image capture device; and
a terminal coupling the remote access device and the image capture device allow the image of the target to appear on the remote access device via the visualization means.

2. The system of claim 1, wherein the terminal is wirelessly coupled to the remote access device.

3. The system of claim 1, wherein the terminal is wirelessly coupled to the image capture device.

4. The system of claim 1, wherein the terminal is wirelessly coupled to the remote access device and the image capture device.

5. The system of claim 1, wherein the means for sending and receiving signals from and to the image capture device comprises a hub coupled to the image capture device having means for sending and receiving wireless signals to the terminal.

6. The system of claim 1, wherein the remote access device is from the group comprising laptop computers, desk top computers, personal digital assistants, table personal computers, smart phones, or cellular telephones.

7. The system of claim 1, wherein the image capture device is a digital camera.

8. The system of claim 1, wherein the image capture device is a digital camcorder.

9. The system of claim 1, wherein the terminal is a WiFi receiver.

10. The system of claim 1, wherein the remote access device can view the image of the target that is found on the image capture device through the visualization means.

11. The system of claim 10, wherein the remote access device sends signals to the means for viewing the image of the target.

12. A system for remote target capture, comprising:
a camera whose image capture circuitry is configured to receive an image of a target within the range of the camera;
a portable electronic device that remotely accesses the image capture circuitry of the camera to capture the image of the target by viewing the image of the target on a display of the portable electronic device;
a terminal coupling the image capture circuitry of the camera and the portable electronic device.

13. The system of claim 12, wherein the portable electronic device wirelessly connects to the terminal to access the image capture circuitry of the camera.

14. The system of claim 13, wherein the camera wirelessly connects to the terminal to allow access to its image capture circuitry.

15. The system of claim 12, wherein the terminal is a wireless or a wired server.

16. The system of claim 12, wherein the portable electronic device is a laptop.

17. The system of claim 12, wherein the portable electronic device is a smart phone device.

18. The system of claim 12, wherein the portable electronic device is a tablet computer.

19. The system of claim 12, wherein the portable electronic device is a cellular telephone.

20. The system of claim 12, wherein the portable electronic device views the target of the image at substantially the same time as the camera.
